(19) United States
(12) Patent Application Publication
(10) Pub. No.: US 2010/0153755 A1
(43) Pub. Date: Jun. 17, 2010

(54) VID PROCESSOR, VOLTAGE GENERATING CIRCUIT AND GENERATING METHOD

(75) Inventor: Ming-Hui Chiu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASMEDIA TECHNOLOGY INC., Taipei (TW)

(21) Appl. No.: 12/631,789

(22) Filed: Dec. 4, 2009

(30) Foreign Application Priority Data
Dec. 11, 2008 (TW) 97148277

(51) Int. Cl. G06F 1/00

(52) U.S. Cl. 713/300

(57) ABSTRACT

A VID processor includes a plurality of buffers, comparators, multiplexers and a core processing unit. The buffer may store a plurality of parameter values and a plurality of offset values. The buffers storing the parameter values may be coupled to the corresponding comparators, and other buffers may be coupled to the corresponding multiplexers. The comparator may compare the VID with the parameter values in the coupled buffer and output a selecting signal to the corresponding multiplexer according to the comparison outcome. Thus, the multiplexer may select and output one of the offset values to the core processing unit from the coupled buffer to allow the core processing unit to adjust the VID according to the output of the multiplexer.

### CROSS-REFERENCE TO RELATED APPLICATION

This application claims the priority benefit of Taiwan application serial no. 97148277, filed on Dec. 11, 2008. The entirety of the above-mentioned patent application is hereby incorporated by reference herein and made a part of specification.

### BACKGROUND OF THE INVENTION

1. Field of the Invention

The invention relates to a circuit for generating an operating voltage and, more particularly, to a circuit for generating an operating voltage of a central processing unit (CPU).

2. Description of the Related Art

In a computer system, an operating voltage needed by a CPU is determined via a dynamic voltage identification code (VID) generated according to its working mode.

FIG. 1 is a block diagram showing a system providing the operating voltage for the CPU in the conventional technology. As shown in FIG. 1, in the computer system, the CPU 102 may generate a VID according to the current working state of the computer device. The VID is transmitted to the pulse width modulation (PWM) signal generator 104 to allow the PWM signal generator to determine the magnitude of the operating voltage (Vcore) according to the value of the VID. When the magnitude of the operating voltage Vcore is determined, the PWM signal generator 104 may provide the operating voltage Vcore for the CPU 102 to allow the CPU 102 to work normally.

The VID is determined by the CPU 102 according to the working state of the computer device. In some cases, the operating voltage Vcore needs to be raised quickly to improve the processing efficiency of the CPU 102. However, in the conventional system, since the VID is changed slowly, the efficiency of the whole system is reduced.

In addition, since the operating voltage of the CPU 102 is limited, the operating voltage Vcore cannot be increased limitlessly. When the operating voltage Vcore reaches a threshold value, if the level of the operating voltage Vcore continues to be increased, the CPU 102 may be damaged.

### BRIEF SUMMARY OF THE INVENTION

The invention discloses a VID processor to improve the efficiency of the CPU.

The invention also discloses a voltage generating circuit which may generate the operating voltage for the CPU to allow the CPU to work most efficiently in a safe range.

In addition, the invention also discloses a method for generating an operating voltage. The operating voltage may be adjusted according to the state of the computer device to allow the CPU to work efficiently.

The invention discloses a VID processor which may process the VID outputted by the CPU. The VID processor in the invention includes a first buffer, a first comparator, a second buffer, a first multiplexer and a core processing unit. The first buffer stores a plurality of first parameter values, and the second buffer stores a plurality of first offset values. The first comparator may receive the VID and is coupled to the first buffer. The first comparator may compare the VID with the first parameter values and output a first selecting signal to the first multiplexer. In addition, the first multiplexer may be coupled to the second buffer. When the first multiplexer receives the first selecting signal, the first multiplexer selects and outputs one of the first offset values to the core processing unit. Thus, the core processing unit may adjust the VID according to the offset value outputted by the first multiplexer and generate an adjusted VID.

In an embodiment of the invention, the VID processor further includes a third buffer, a second comparator, a fourth buffer and a second multiplexer. Similarly, the third buffer may store a plurality of second parameter values, and the fourth buffer may store a plurality of second offset values. In addition, the second comparator may be coupled to the third buffer and compare the VID with the second parameter values to output a second selecting signal to the second multiplexer. The second multiplexer may be coupled to the fourth buffer, and when the second multiplexer receives the second selecting signal, the second multiplexer selects and outputs one of the second offset values to the core processing unit. Thus, the core processing unit may select one of the output of the first multiplexer and the output of the second multiplexer to adjust the VID and generate the adjusted VID.

In another aspect, the invention discloses a voltage generating circuit which may generate an operating voltage for the CPU. The voltage generating circuit in the invention includes a VID processor and a PWM signal generator. The VID processor may receive the VID outputted by the CPU, and the VID processor further compares the VID with a plurality of first parameter values to generate a first comparison outcome. Thus, the VID processor may adjust the VID according to the first comparison outcome and generate an adjusted VID. The PWM signal generator may receive the adjusted VID to generate the operating voltage of the CPU.

In an embodiment of the invention, the VID processor may compare the VID with a plurality of second parameter values to generate a second comparison outcome. The VID processor also may generate the adjusted VID according to the second comparison outcome.

The first parameter values and the second parameter values may be boundary values and region values, respectively.

From another aspect, the invention also discloses a method for generating an operating voltage adapted to a CPU in a computer system. The method for generating the operating voltage in the invention includes comparing a VID outputted by the CPU with a plurality of first parameter values to generate a comparison outcome to determine the working mode of the computer system. In addition, in the invention one of the offset values is selected according to the working mode of the computer system to add the absolute value of the selected offset value to the VID or subtract the absolute value of the selected offset value from the VID and generate an adjusted VID. The adjusted VID is not greater than the maximum first parameter value and not less than the minimum first parameter value. Thus, in the invention, the operating voltage may be generated for the CPU according to the adjusted VID.

In an embodiment of the invention, when the VID is greater than the maximum first parameter value, the operating voltage is generated with the maximum first parameter value as a new VID.

In addition, if the VID is less than the minimum first parameter value, the operating voltage is generated with the minimum first parameter value as the new VID.

In the invention, an absolute value of the offset value may be added to the VID or subtracted from the VID according to the state of the computer system. Thus, the efficiency of the CPU may be increased efficiently. In addition, when the VID is greater than the maximum first parameter value, the maximum first parameter value is regarded as the new VID, and thus the CPU may be protected from being damaged.

These and other features, aspects and advantages of the present invention will become better understood with regard to the following description, appended claims, and accompanying drawings.

### BRIEF DESCRIPTION OF THE DRAWINGS

FIG. 1 is a block diagram showing a system providing an operating voltage for a CPU in the conventional technology.

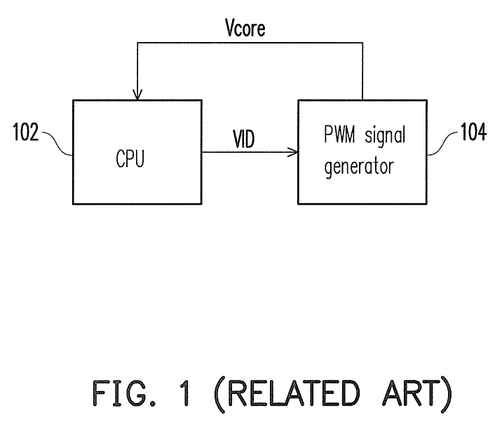

FIG. 2 is a block diagram showing a computer system in a preferred embodiment of the invention.

FIG. 3 is a circuit block diagram showing a voltage generating circuit in a preferred embodiment of the invention.

FIG. 4 is a system block diagram showing the VID processor in a preferred embodiment of the invention.

FIG. 5 is a schematic diagram showing the relation between the boundary values and the region values in a preferred embodiment of the invention.

FIG. 6 is a flow chart showing a method for generating the operating voltage in a preferred embodiment of the invention.

### DETAILED DESCRIPTION OF THE EMBODIMENTS

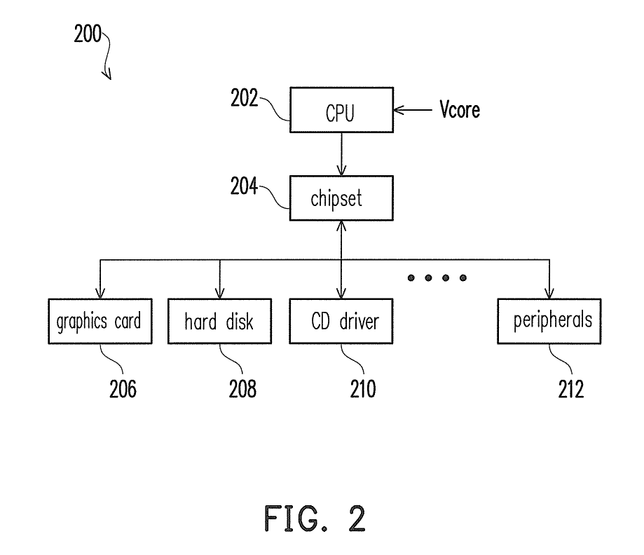

FIG. 2 is a block diagram showing a computer system in a preferred embodiment of the invention. As shown in FIG. 2, the computer system 200 in the embodiment includes a CPU 202, a chipset 204 and a plurality of hardware devices. The hardware devices may be a graphics card 206, a hard disk 208, a compact disk (CD) driver 210 and peripheral devices 212. The hardware devices may be coupled to the chipset 204, and the chipset 204 may be coupled to the CPU 202. Thus, the CPU 202 may control the hardware devices via the chipset 204.

The CPU 202 is operated according to an operating voltage Vcore. The magnitude of the operating voltage Vcore is determined according to the state of the computer system 200. For example, in some cases such as when the graphics card 206, the hard disk 208 and the peripheral devices 212 are operated at the same time, the CPU 202 needs higher operating voltage Vcore to operate. This state is called a heavy load mode. Correspondingly, in some cases such as when the computer system 100 is in a standby mode, the CPU 202 only needs lower operating voltage Vcore to keep working. Thus, the state is called the power-saving mode.

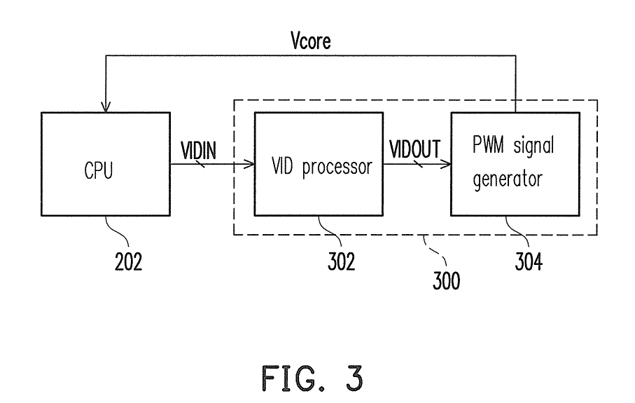

FIG. 3 is a circuit block diagram showing the voltage generating circuit in a preferred embodiment of the invention. As shown in FIG. 3, the voltage generating circuit 300 in the embodiment further determines the magnitude of the operating voltage Vcore according to the VIDIN outputted by the CPU 304. The voltage generating circuit 300 includes a VID processor 302 and a PWM signal generator 304. The VID processor 302 may be coupled to the CPU 202 to receive the VIDIN. In addition, the VID processor 302 also may be coupled to the PWM signal generator 304.

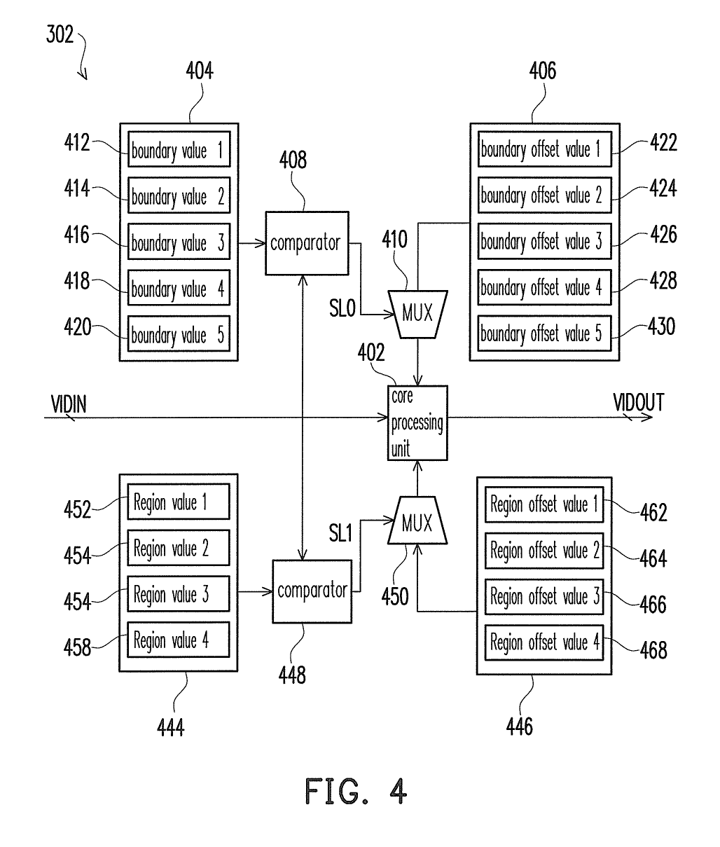

FIG. 4 is a system block diagram showing the VID processor in a preferred embodiment of the invention. As shown in FIG. 4, the VID processor 302 includes at least a core processing unit 402, buffers 404 and 406, a comparator 408 and a multiplexer (MUX) 410. The buffers 404 and 406 may be respectively coupled to the comparator 408 and the multiplexer 410, and the multiplexer 410 also may be coupled to the comparator 408 and the core processing unit 402.

The buffer 404 may have a plurality of storage blocks 412, 414, 416, 418 and 420 to store a plurality of first parameter values. In the embodiment, the first parameter values are boundary values 1 to 5. In addition, the buffer 406 also may have storage blocks 422, 424, 426, 428 and 430 to store a plurality of boundary offset values 1 to 5.

In some other selective embodiments, the VID processor 302 also may include buffers 444 and 446, a comparator 448 and multiplexer 450. Similarly, the buffers 444 and 446 may be coupled to the comparator 448 and the multiplexer 450, respectively. The multiplexer 450 also may be coupled to the comparator 448 and the core processing unit 402.

Both the buffers 444 and 446 may include a plurality of storage blocks 452, 454, 456, 458, 462, 464, 466 and 468. In the embodiment, the buffer 444 may store a plurality of second parameter values such as the region values 1 to 4. Correspondingly, the buffer 446 may include a plurality of region offset values 1 to 4.

In the embodiment, the region offset value 1 and the boundary offset value 1 may be set to be −4. The region offset value 2 and the boundary offset value 2 may be set to be −2. The region offset value 3 and the boundary offset value 3 may be set to be +2. The region offset value 4 may be set to be +4. By defining each parameter and offset value in the embodiment, a skilled person in the art may further know the spirit of the invention, but the invention is not limited thereto. A skilled person in the art may set every parameter value and offset value according to the actual situation.

As show in FIG. 4, the core processing unit 402 may receive the VIDIN, and the VIDIN also may be transmitted to the comparators 408 and 448, respectively. When the comparators 408 and 448 receive the VIDIN, they may compare the VIDIN with the boundary values 1 to 5 stored in the buffer 404 and the region values 1 to 4 stored in the buffer 444, and thus they generate a first comparison outcome and a second comparison outcome, respectively. In addition, the comparators 408 and 448 may generate and output selecting signals SL0 and SL1 to the multiplexers 410 and 450 according to the first comparison outcome and the second comparison outcome, respectively.

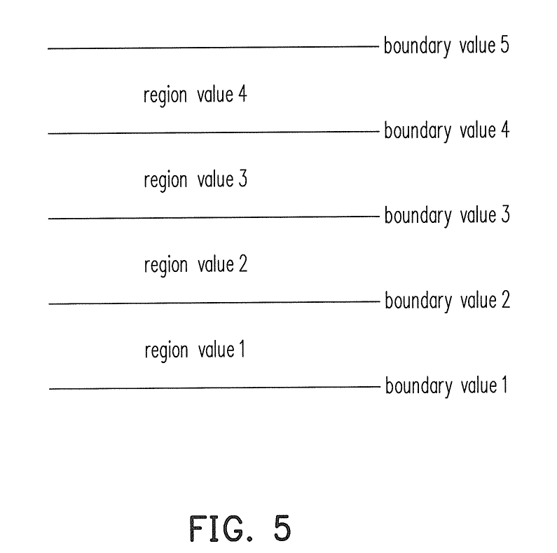

FIG. 5 is a schematic diagram showing the relation between the boundary values and the region values in a preferred embodiment of the invention. As shown in FIG. 4 and FIG. 5, if the comparators 408 and 448 determine that the value of the VIDIN equals to the boundary value 2 or falls in the region value 1, it means that the computer system may work in the power-saving mode. Thus, the multiplexer 410 may select the boundary offset value 1 according to the selecting signal SL0 or select the region offset value 1, and the multiplexer 450 may output boundary offset value 1 or the region offset value 1 to the core processing unit 402. At that moment, the core processing unit 402 may adjust the VIDIN according to the output of the multiplexers 410 or 450 and generate the VIDOUT (adjusted VID).

In some embodiments, the method for adjusting the core processing unit 402 may be adding the boundary offset value 1 or the region offset value 1 to the VIDIN to generate the VIDOUT which is a new VID. In other words, the core processing unit 402 may subtract the absolute value of the boundary offset value 1 or the absolute value of the region offset value 1 from the VIDIN to generate the VIDOUT. The VIDOUT may be sent to, for example, the PWM signal generator 304 in FIG. 3. At that moment, the PWM signal generator 304 may determine the magnitude of the operating voltage Vcore according to the VIDOUT.

If the comparator 408 or 448 determines that the VIDIN equals to the boundary value 3 or falls in the region value 2, it means that the computer system works in the power-saving mode, but efficiency higher than that in the former state is needed. Thus, the multiplexer 410 may select and output the boundary offset value 2 according to the selecting signal SL0, or the multiplexer 450 may select and output the region offset value 2 according to the selected signal SL1. At that moment, the core processing unit 402 may add the boundary offset value 2 or the region offset value 2 to the VIDIN, or subtract the absolute value of the boundary offset value 2 or the absolute value of the region offset value 2 from the VIDIN to generate the VIDOUT.

When the comparator 408 or 448 determines that the VIDIN equals to the boundary value 4 or falls in the region value 3, it means that the computer system may work in the heavy load mode. Thus, the multiplexer 410 may select and output the boundary offset value 3, or the multiplexer 450 selects and outputs the region offset value 3 to the core processing unit 402. At that moment, the core processing unit 402 may add the boundary offset value 3 or the region offset value 3 to the VIDIN to generate the VIDOUT to increase the value of the operating voltage Vcore quickly.

If the comparator 448 determines that the VIDIN falls in the region value 4, it means that the computer system needs efficiency higher than that in the former state. Thus, the multiplexer 510 may select and output the region offset value 4 to the core processing unit 402. At that moment, the core processing unit 402 may add the region offset value 4 to the VIDIN to generate the VIDOUT. Thus, the level of the operating voltage Vcore may be increased quickly.

To prevent the CPU 202 from being damaged due to the overhigh operating voltage Vcore, when the comparator 408 determines that the VIDIN is greater than or equal to the boundary value 5, it outputs a selecting signal SL0 to the multiplexer 410 to make the multiplexer 410 select and output the boundary value 5 to the core processing unit 402 directly. At that moment, the core processing unit 402 may use the boundary value 5 as the VIDOUT and output the boundary value 5 to the PWM signal generator 304 to prevent the CPU 202 from being damaged.

Correspondingly, to make the CPU 202 work non normally, when the comparator 408 determines that the VIDIN is less than or equal to the boundary value 1, it may output the selecting signal SL0 to the multiplexer 410 to make the multiplexer 410 select and output the boundary value 1 to the core processing unit 402 directly. Thus, the core processing unit 402 may output the boundary value 1 as the VIDOUT to the PWM signal generator 304. Thus, the CPU 202 may work normally.

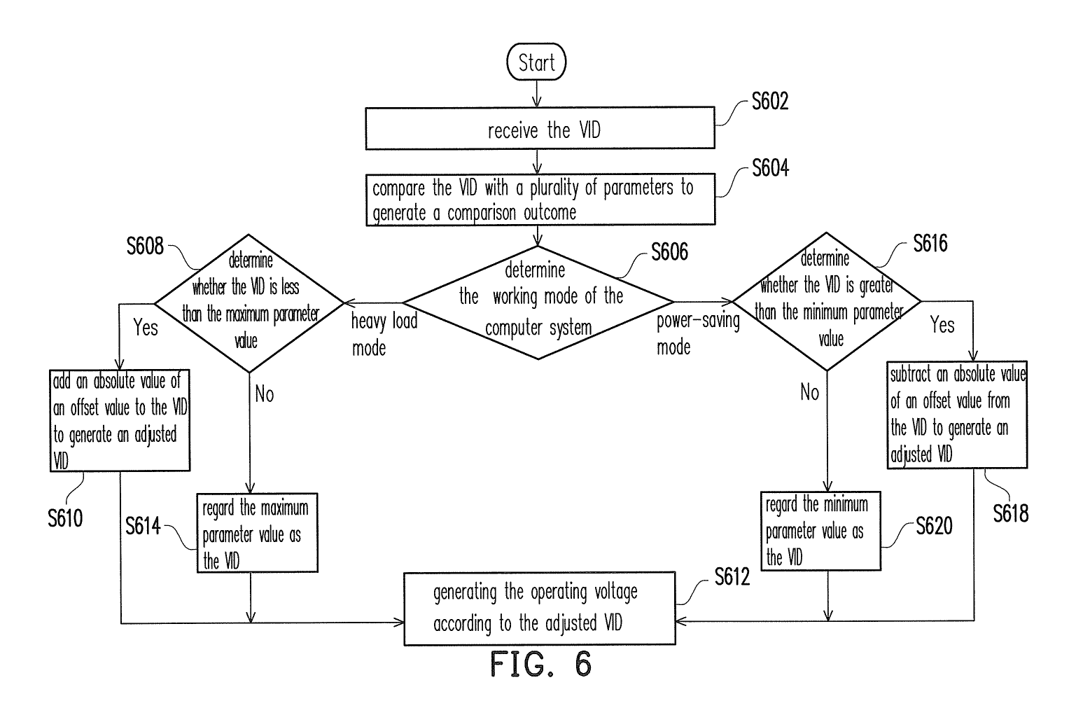

FIG. 6 is a flow chart showing the method for generating an operating voltage in a preferred embodiment of the invention. As shown in FIG. 6, the method for generating an operating voltage may be used to generate the operating voltage for a CPU of a computer system. As shown in step S602, a VID is received. As shown in step S604, the VID is compared with a plurality of parameter values to generate a comparison outcome. Thus, step S606 is performed, and the working state of the computer system is determined according to the comparison outcome.

If it is determined that the computer system works in the heavy load mode, as shown in step S608, whether the VID is less than the maximum value of the parameter values is determined. If the received VID is less than the maximum parameter value (the “yes” denoted in step S608), as shown in step S610, an absolute value of the offset value is added to the VID to generate an adjusted VID. Thus, as shown in step S612, an operating voltage of the CPU is generated according to the adjusted VID.

On the contrary, if it is determined that the VID is greater than or equal to the maximum parameter value (the “no” denoted in step S608), as shown in step S614, the maximum parameter value is used as the adjusted VID to perform step S612.

Correspondingly, if the computer system is determined to work in the power-saving mode in step S606, step S616 is performed, and that is, whether the VID is greater than the minimum value of the parameter values is determined. If the VID is greater than the minimum parameter value (the “yes” denoted in step S616), as shown in step S618, an absolute value of the offset value is subtracted from the VID to generate an adjusted VID, and then step S612 is performed. On the contrary, if the VID is determined less than or equal to the minimum parameter value (the “no” denoted in step S616), step S620 is performed. The minimum parameter value is used as the adjusted VID, and the step S612 is performed.

To sum up, in the invention, the state of the computer system is determined according to the relation between the VID and a plurality of parameter values, and the adjusted VID is generated by adjusting the original VID according to the state of the computer system. Thus, the efficiency of the computer system is improved. In addition, when the original VID of the invention is higher or lower than a threshold value, the VID may be locked. Thus, the CPU would not be damaged and may work normally.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A voltage identification code (VID) processor adapted to process a VID outputted by a central processing unit (CPU), the VID processor comprising:
a first buffer storing a plurality of first parameter values;
a first comparator coupled to the first buffer, receiving the VID, comparing the VID with the plurality of first parameter values and outputting a first selecting signal;
a second buffer storing a plurality of first offset values;
a first multiplexer coupled to the first comparator and the second buffer, wherein when the first multiplexer receives the first selecting signal, the first multiplexer selects and outputs one of the plurality of first offset values; and
a core processing unit coupled to the first multiplexer, receiving the VID, adjusting the VID according to the offset value outputted by the first multiplexer and generating an adjusted VID.

2. The VID processor according to claim 1, further comprising:
a third buffer storing a plurality of second parameter values;
a second comparator coupled to the third buffer, receiving the VID, comparing the VID with the plurality of second parameter values and outputting a second selecting signal;
a fourth buffer storing a plurality of second offset values; and
a second multiplexer coupled to the second comparator and the fourth buffer to select and output one of the plurality of second offset values to the core processing unit when the second multiplexer receives the second selecting signal,
wherein the core processing unit selects at least one of the output of the first multiplexer and the output of the second multiplexer to adjust the VID and generates the adjusted VID.

3. The VID processor according to claim 2, wherein the first parameter values and the second parameter values are a plurality of boundary values and a plurality of region values, respectively.

4. The VID processor according to claim 3, wherein when the VID is greater than the maximum boundary value of the plurality of boundary values, the core processing unit replaces the VID with the maximum boundary value.

5. The VID processor according to claim 3, wherein when the VID is less than the minimum boundary value of the boundary values, the core processing unit replaces the VID with the minimum boundary value.

6. A voltage generating circuit adapted to generate an operating voltage for a CPU, the voltage generating circuit comprising:
a VID processor receiving a VID outputted by the CPU, wherein the VID processor further compares the VID with a plurality of first parameter values to generate a first comparison outcome, and the VID processor further adjusts the VID according to the first comparison outcome and generates an adjusted VID; and
a PWM signal generator coupled to the VID processor to receive the adjusted VID and generate the operating voltage of the CPU.

7. The voltage generating circuit according to claim 6, wherein the VID processor further compares the VID with a plurality of second parameter values to generate a second comparison outcome, and the VID processor further adjusts the VID according to the second comparison outcome and generates the adjusted VID.

8. The voltage generating circuit according to claim 7, wherein the first parameter values and the second parameter values are a plurality of boundary values and region values, respectively.

9. The voltage generating circuit according to claim 8, wherein when the value of the VID is larger than the maximum boundary value of the boundary values, the VID processor replaces the VID with the maximum boundary value and outputs the maximum boundary value to the PWM signal generator.

10. The voltage generating circuit according to claim 8, wherein the VID is less than the minimum boundary value of the boundary value, the VID processor replaces the VID with the minimum boundary value and outputs the minimum boundary value to the PWM signal generator.

11. A method for generating an operating voltage adapted for a CPU in a computer system, the method comprising the steps of:
comparing a VID outputted by the CPU with a plurality of first parameter values and generating a comparison outcome to determine a working mode of the computer system;
adding a first offset value to the VID and generating an adjusted VID when the working mode is a heavy load mode, wherein the adjusted VID is not greater than the maximum value of the plurality of first parameter values;
subtracting a second offset value from the VID and generating the adjusted VID when the working mode is a power-saving mode, wherein the adjusted VID is not less than the minimum value of the plurality of first parameter values; and
generating the operating voltage and outputting the operating voltage to the CPU according to the adjusted VID.

12. The method for generating the operating voltage according to claim 8, further comprising the steps of:
generating the operating voltage with the maximum first parameter value as a adjusted VID when the VID is greater than the maximum value of the first parameter values; and
generating the operating voltage with the minimum first parameter value as the adjusted VID when the VID is less than the minimum value of the first parameter values.
